(19) United States
(12) Patent Application Publication
(10) Pub. No.: US 2010/0102588 A1
(43) Pub. Date: Apr. 29, 2010

(54) Heat shield assembly

(76) Inventor: Siao-Ping Li, Taidong City (TW)

Correspondence Address: COOPER & DUNHAM, LLP, 30 Rockefeller Plaza, 20th Floor, NEW YORK, NY, 10112, US

(21) Appl. No.: 12/290,260

(22) Filed: Oct. 29, 2008

(51) Int. Cl. B60J 11/02

(52) U.S. Cl. 296/98

(57) ABSTRACT

A heat shield assembly is applied to and shields an automobile from the sunlight and has a winding rod and a main heat shield. The main heat shield is connected to and selectively winds around the winding rod and has multiple main shielding strips. The main shielding strips are semi-tubular, are connected together and each main shielding strip has a convex surface, a concave surface and a ventilation passageway. The ventilation passageway allows the air flows therethrough to dissipate the heat of the main shielding strip and the automobile.

### BACKGROUND OF THE INVENTION

1. Field of the Invention

The present invention relates to a curtain assembly, and more particularly to a heat shield assembly that is applied to automobiles to shield the automobiles from the sunlight and has ventilation passageways allowing airflow to flow therethrough to achieve heat-dissipation of automobiles.

2. Description of Related Art

Automobiles parked on the ground are always exposed to the sunlight so that the dashboards, car-seats and other miscellaneous articles such as cellular phones and laptops inside the automobiles would be overheated and probably damaged after a period of exposure to the sun due to the transparent windows of the automobiles. To isolate the sunlight, a heat-shielding paper used to cover the windows has been developed.

A conventional heat-shielding paper is soft and foldable and has a golden or silver reflection surface. When used, the heat-shielding paper is attached to and covers the windscreens and windows of an automobile with the reflection surface facing outwards to prevent the sunlight from radiating through the windscreens and windows.

However, the heat-shielding paper is attached tightly to and contacts the automobile in a large contacting area without ventilation gaps therebetween so that heat on the heat-shielding paper is transmitted to the automobile by heat conduction, which raises the temperature inside the automobile.

To overcome the shortcomings, the present invention provides a heat shield assembly to mitigate or obviate the aforementioned problems.

### SUMMARY OF THE INVENTION

The main objective of the invention is to provide a heat shield assembly that is applied to automobiles to shield the automobiles from the sunlight and has ventilation passageways allowing airflow to flow therethrough to achieve the heat-dissipation of automobiles.

A heat shield assembly in accordance with the present invention is applied to and shields an automobile from the sunlight and has a winding rod and a main heat shield. The main heat shield is connected to and selectively winds around the winding rod and has multiple main shielding strips. The main shielding strips are semi-tubular, are connected together and each main shielding strip has a convex surface, a concave surface and a ventilation passageway. The ventilation passageway allows the air flows therethrough to dissipate the heat of the main shielding strip and the automobile.

Other objectives, advantages and novel features of the invention will become more apparent from the following detailed description when taken in conjunction with the accompanying drawings.

### BRIEF DESCRIPTION OF THE DRAWINGS

FIG. 1 is an operational perspective view of a heat shield assembly in accordance with the present invention applied to an automobile;

FIG. 2A is an operational side view of the heat shield assembly in FIG. 1 on the automobile;

FIG. 2B is an enlarged perspective view of the hook and loop fasteners of the heat shield assembly in FIG. 1;

FIG. 3 is a perspective view of the heat shield assembly in FIG. 1 with the side curtains folded; and

FIG. 4 is a perspective view of the heat shield assembly in FIG. 3 showing that the heat shield assembly is fully folded and wound around the winding rod.

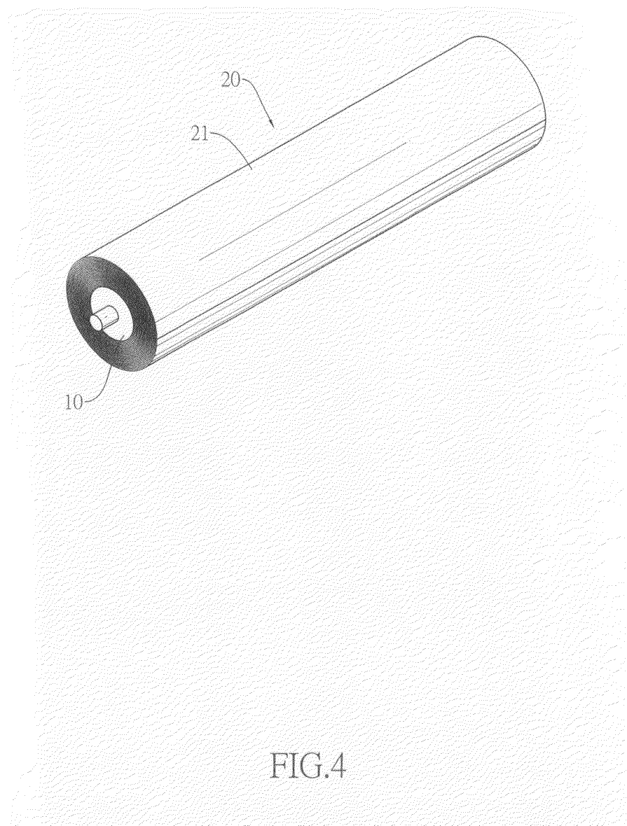

### DETAILED DESCRIPTION OF THE PREFERRED EMBODIMENT

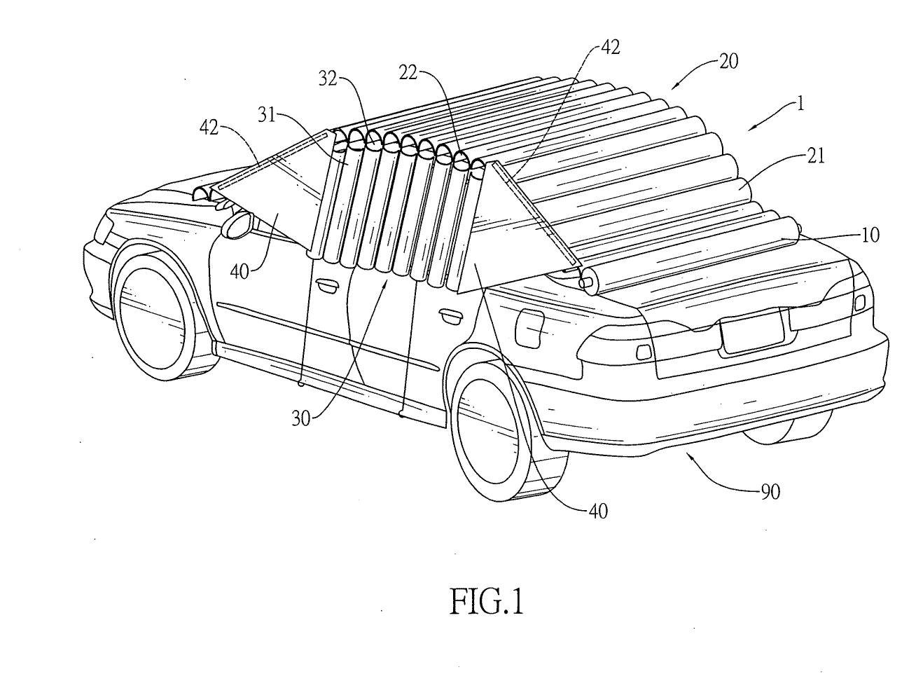

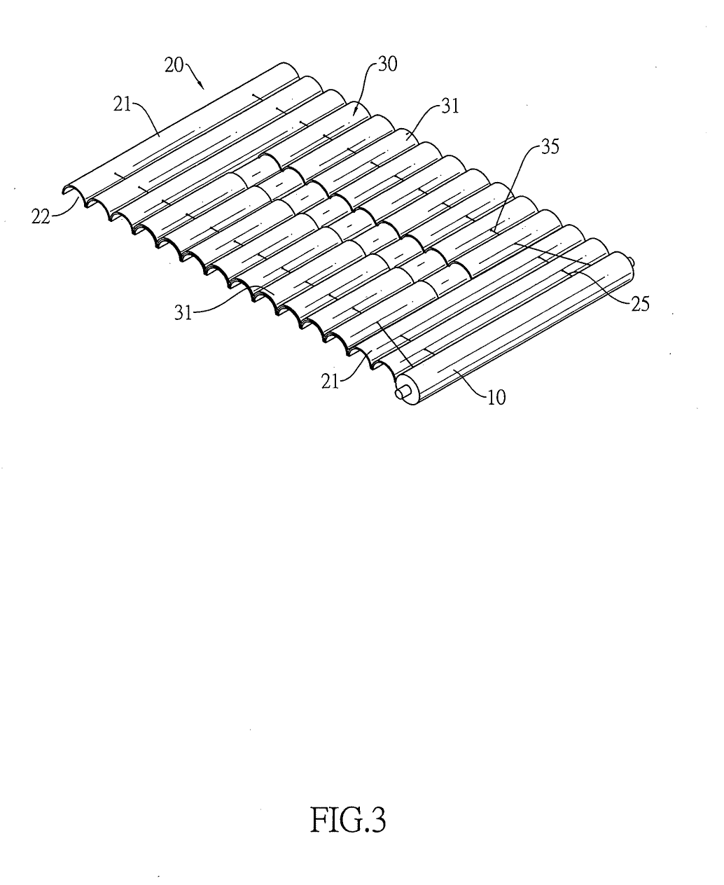

With reference to FIGS. 1, 2A and 3, a heat shield assembly in accordance with the present invention is attached to an automobile (90) to cover the front and windscreens and two opposite side windows of the automobile (90).

The heat shield assembly comprises a winding rod (10), a main heat shield (20) and two opposite side heat shields (30) and may further have two opposite pairs of intermediate covers (40).

The winding rod (10) is longitudinal and may be mounted on the trunk cover or engine cover of the automobile (90) by fastening means such as hook and loop fasteners and adhesives.

The main heat shield (20) is connected to and is capable of winding around the wind rod (10), may cover the front and rear windscreens and the roof of the automobile (90) and has two opposite side edges and multiple main shielding strips (21).

The main shielding strips (21) are resilient and semi-tubular to fit the winding rod (10) when winding around the winding rod (10), may be made of paper or plastic, are connected together in a row through threads (25). Each main shielding strip (21) has a convex surface, a concave surface and a ventilation passageway (22).

The convex surface may be polished and face outwards to reflect the sunlight.

The concave surface may face the automobile (90) when the main heat shield (20) is attached to the automobile (90).

The ventilation passageway (22) is defined in the concave surface adjacent to the automobile (90). The ventilation passageway (22) prevents the main shielding strip (21) from contacting the automobile (90) in a large contacting area and allows ambient air to flow through the ventilation passageway (22) for dissipating the heat of the main shielding strip (21) and the automobile (90).

The side heat shields (30) are foldably connected respectively to the side edges of the main heat shield (20), may respectively cover the side windows of the automobile (90) and selectively winds around the winding rod (10) after folded to the main heat shields (20). Each side heat shield (30) has multiple side shielding strips (31).

The side shielding strips (31) are resilient and semi-tubular to fit the winding rod (10) when winding around the winding rod (10), may be made of paper or plastic and are connected together in a row through at least one thread (35). Each side shielding strip (31) has two ends, a convex surface, a concave surface and a ventilation passageway (32).

The convex surface of the side shielding strip (31) may be polished and face outwards to reflect the sunlight.

The concave surface of the side shielding strip (31) faces the automobile (90) when the side heat shield (30) is attached to the automobile (90). Furthermore, the side shielding strip (31) is capable of being bent and flipped to change the original convex surface to a concave surface and change the original concave surface to a convex surface.

The ventilation passageway (32) is defined in the concave surface of the side shielding strip (31) adjacent to the automobile (90). The ventilation passageway (32) prevents the side shielding strip (31) from contacting the automobile (90) in a large contacting area and allows ambient air to flow through the ventilation passageway (32) for dissipating the heat of the side shielding strip (31) and the automobile (90).

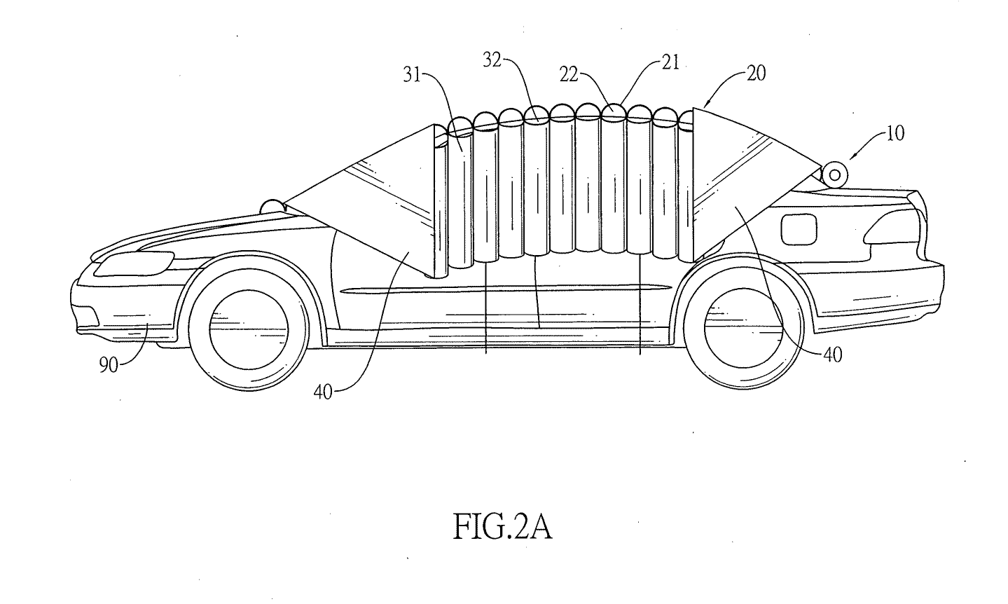

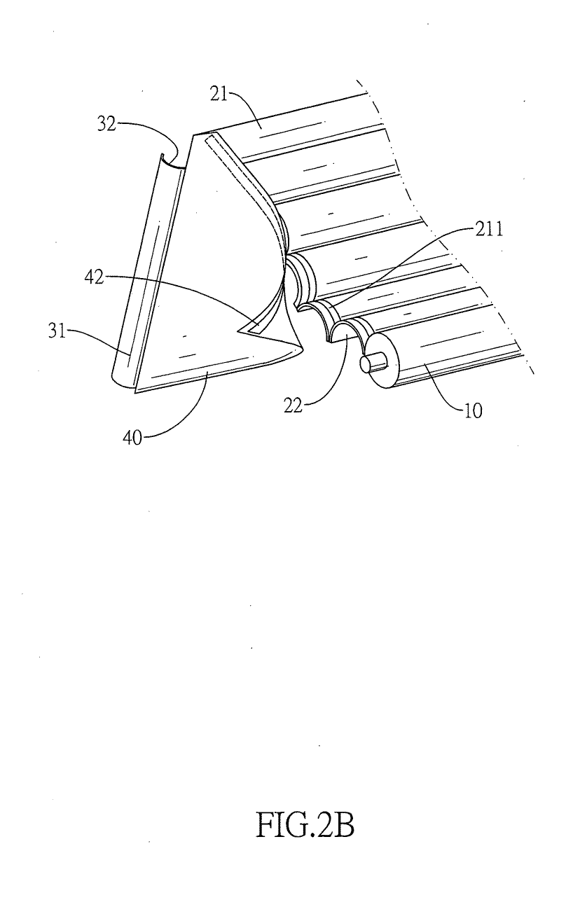

With further reference to FIG. 2B, the pairs of the intermediate covers (40) correspond respectively to the side heat shields (30) and may cover the windows of the automobile (90). The intermediate covers (40) of each pair may be made of fabric or paper, are connected respectively to the ends of a corresponding side heat shield (30) and are selectively attached to one side edge of the main heat shield (20). Each intermediate cover (40) may be triangular and has a fastener assembly. The fastener assembly has a first fastener (42) and a second fastener (211). The first fastener (42) may be a hook fastener, may be a loop fastener and is mounted securely on the intermediate cover (40). The second fastener (211) is mounted securely on one side edge of the main heat shield (20), may be a loop fastener, may be a hook fastener and is engaged detachably with the first fastener (42).

The main and side heat shields (20, 30) with the ventilation passageways (22, 32) prevents the main and side shielding strips (21, 31) from contacting the automobile (90) in large areas that incurs the heat conduction. Furthermore, ventilation passageways (22, 32) allows the ambient air to flow therethrough to dissipate the heat of the main and side shielding strips (21, 31) of the automobile (90). Therefore, the heat shield assembly has excellent heat shield and dissipation performance.

Even though numerous characteristics and advantages of the present invention have been set forth in the foregoing description, together with details of the structure and function of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A heat shield assembly comprising:
a winding rod being longitudinal;
a main heat shield connected to and being capable of winding around the wind rod and having
two opposite side edges; and
multiple main shielding strips being resilient and semi-tubular, connected together in a row and each main shielding strip having
a convex surface;
a concave surface; and
a ventilation passageway defined in the concave surface.

2. The heat shield assembly as claimed in claim 1 further comprising two opposite side shields foldably connected respectively to the side edges of the main heat shield, selectively winding around the winding rod, each side heat shield having multiple side shielding strips being resilient and semi-tubular, connected together in a row and each side shielding strip having
two ends;
a convex surface;
a concave surface; and
a ventilation passageway defined in the concave surface of the side shielding strip.

3. The heat shield assembly as claimed in claim 2, wherein the main shielding strips are connected together through threads.

4. The heat shield assembly as claimed in claim 3, wherein the side shielding strips of each side shield are connected together through at least one thread.

5. The heat shield assembly as claimed in claim 4, wherein
the heat shield assembly further comprises two opposite pairs of intermediate covers corresponding respectively to the side heat shields;
the intermediate covers of each pairs are connected respectively to the ends of a corresponding side heat shield, are selectively attached to one side edge of the main heat shield and each intermediate cover has a fastener assembly having
a first fastener mounted securely on the intermediate cover; and
a second fastener mounted securely on one side edge of the main heat shield and engaged detachably with the first fastener.

6. The heat shield assembly as claimed in claim 5, wherein each side shielding strip is capable of being bent and flipped to change the convex surface of the side shield strip to a concave surface and change the concave surface of the side shield strip to a convex surface.

7. The heat shield assembly as claimed in claim 6, wherein the main and side shielding strips are made of paper.

8. The heat shield assembly as claimed in claim 6, wherein the main and side shielding strips are made of plastic.

9. The heat shield assembly as claimed in claim 6, wherein each intermediate cover is made of paper.

10. The heat shield assembly as claimed in claim 6, wherein each intermediate cover is made of fabric.
